(19) United States
(12) Patent Application Publication
(10) Pub. No.: US 2017/0174999 A1
(43) Pub. Date: Jun. 22, 2017

(54) METHOD OF MANUFACTURING REFINED PITCH

(71) Applicant: NATIONAL CHUNG SHAN INSTITUTE OF SCIENCE AND TECHNOLOGY, Taoyuan City (TW)

(72) Inventors: HSIN-PING CHANG, NEW TAIPEI CITY (TW); CHUEN-MING GEE, HSINCHU COUNTY (TW); PAI-LU WANG, TAIPEI CITY (TW); CHING-JANG LIN, TAOYUAN CITY (TW)

(21) Appl. No.: 14/973,801

(22) Filed: Dec. 18, 2015

(51) Int. Cl. C10C 3/00; B01D 21/00; B01D 3/10; C10C 3/06

(52) U.S. Cl. CPC C10C 3/002; C10C 3/06; B01D 21/009; B01D 3/10

(57) ABSTRACT

A method of manufacturing a refined pitch includes the steps of providing a pitch and performing a heated blending process thereon to produce a pitch solution; adding an aromatic additive to the pitch solution; adding an aliphatic additive to the pitch solution; performing a quiescent sedimentation process on the pitch solution; and separating a liquid part from the pitch solution. Therefore, the method allows a concentrated mesophase pitch to be manufactured quickly and by heat processing.

### FIELD OF TECHNOLOGY

The present invention relates to methods of manufacturing a refined pitch and more particularly to a method of manufacturing concentrated mesophase pitch quickly and by heat processing.

### BACKGROUND

Pitch can have a maximum of 90% carbon content and thus is highly graphitized. Hence, pitch is a good source of carbon raw materials and is available widely and cheaply. Pitch is usually composed of by-products (such as petroleum refined residues, petroleum residues, coal tar oil, and coal pitch) of petroleum and coal processing processes and traces of pure aromatic hydrocarbons. Tar undergoes distillation at 300˜400° C., and its solid residues are generally known as pitch. Depending on its sources, pitch falls into two categories, namely coal tar pitch and petroleum pitch.

Pitch contains a fixed amount of solid particles. The solid particles of coal tar pitch, which are produced during a coal tar production process in which ascending coal gas carries coal ash, powder peeled off fire-resistant walls of a furnace, oxide powder and iron scraps detached from corroded furnace doors and gas pipes, are of a particle diameter of 10 μm or so, or comprise coal tar powder or carbon black of a particle diameter of about 25 μm. The solid particles of petroleum pitch consist of iron scraps detached from corrode apparatuses used in a petroleum catalyst-enhanced manufacturing process. The aforesaid solid particles are insoluble in a quinoline solvent, and thus the solid particles are generally known as quinoline insoluble (QI). The QI is tested by ASTM D2318. QI, which has a particle diameter of 10˜25 μm, is widely suspended in pitch, and pitch has a large viscosity coefficient; hence, it is difficult to remove the QI from pitch. The QI bucks the production and fusion of mesophase pitch, and thus pitch cannot be turned into highly orientated and optically anisotropic mesophase pitch. When used in a carbon fiber spinning process, the QI is likely to clog spinning apertures, and residues of the QI may remain inside carbon fiber products, thereby causing the carbon fibers to sever. Hence, to apply pitch to high-quality carbon raw materials, it is necessary to effectively remove the QI from pitch and thus obtain refined pitch with low QI content.

Pitch comprises toluene insoluble (TI) with moderate molecular weights. The TI of pitch is also known as β resin. The β resin accounts for the high adhesiveness of the pitch. The β resin content of high-quality pitch must be larger than 18%. Hence, it is important to adjust the β resin content of pitch. The β resin content of pitch is calculated by subtracting QI content from TI content; hence, β resin approximates to TI content whenever QI content is insignificant.

A conventional method of manufacturing a refined pitch requires separating QI from pitch. For example, U.S. Pat. No. 4,259,171 discloses, in an embodiment thereof, mixing 200 g of pitch, 90 g of kerosene and 90 g of methyl naphthalene and then performing a heat processing process on the mixture at an operating temperature of 250±3° C., under an operating pressure of 2.1 bar, and for 3 hours to finally obtain 150 g of refined pitch, with a softening point of around 64° C., QI content of 0.08 wt %, TI content of 14.7 wt %, and β resin content of 14.6 wt %. In another embodiment of U.S. Pat. No. 4,259,171, 200 g of pitch, 83 g of kerosene and 83 g of benzene are mixed, and then the mixture undergoes the aforesaid process under the aforesaid operating conditions to produce refined pitch with a 90% yield, a softening point of 56° C., QI content of 0.1 wt %, TI content of 13.0 wt %, and β resin content of 12.9 wt %.

U.S. Pat. No. 4,259,171 has three drawbacks as follows: (1) the first embodiment requires an operating temperature of at least 200° C. and an operating pressure of 2.1 bar, and in consequence the pressurization and heat processing requirements pose a safety risk to workers and equipment; (2) the second embodiment requires using the toxic solvent “benzene” as a pitch extraction solvent, thereby posing a safety risk to workers; and (3) the pitch obtained in the first and second embodiments has an overly low softening point of 64° C. and 56° C., respectively, thereby bringing inconvenience to the pre-processing tasks.

U.S. Pat. No. 4,517,072 discloses carrying out QI content extraction with n-methyl-2-pyrrolidone solvent, wherein tar and n-methyl-2-pyrrolidone are mixed at different ratios and at an operating temperature of 75˜95° C., and then the mixture undergoes a distillation process to produce a pitch. Unfortunately, according to U.S. Pat. No. 4,517,072, the QI content of the pitch thus produced is reduced to just 0.7 wt %. U.S. Pat. No. 4,517,072 has two drawbacks as follows: the QI content of the refined pitch is reduced to just 0.7 wt %; and n-methyl-2-pyrrolidone is expensive, thereby adding to costs.

In view of this, it is imperative to provide a method of manufacturing a refined pitch, characterized in that: the pitch operating temperature is low, for example, below 200° C.; the pitch includes cheap aromatic additives and aliphatic additives; QI is removed from the pitch because of the difference in solubility between solvents; and a refined pitch with less than 0.05 wt % QI content is produced. The aforesaid characteristics of the refined pitch and its manufacturing method aim to strike a balance between cost and time-efficiency such that a concentrated mesophase pitch can be produced quickly and by heat processing.

### SUMMARY

In view of the aforesaid drawbacks of the prior art, it is an objective of the present invention to provide a method of manufacturing a refined pitch, by adding an aromatic additive and an aliphatic additive to a pitch and then performing a quiescent sedimentation process on the pitch so as to produce a concentrated mesophase pitch quickly and by heat processing.

In order to achieve the above and other objectives, the present invention provides a method of manufacturing a refined pitch, including the steps of: providing a pitch and performing a heated blending process thereon to produce a pitch solution; adding an aromatic additive to the pitch solution; adding an aliphatic additive to the pitch solution; performing a quiescent sedimentation process on the pitch solution; and separating a liquid part from the pitch solution.

In step A, the heated blending process is performed at a control temperature to heat and soften the pitch such that the solid pitch turns gradually into a viscous pitch solution. The control temperature is 100˜200° C., preferably 120˜180° C., at which the pitch is softened to turn into a pitch solution. The pitch is blended without sticking to a blender, but the present invention is not limited thereto.

Step B entails adding an aromatic additive to the pitch solution to reduce the coefficient of viscosity of the pitch and thus enhance the readiness of the pitch solution to flow, thereby facilitating subsequent steps. It is because the pitch remains viscous even after it has been heated beyond the softening point. Adding the aromatic additive to the viscous pitch solution ensures that the viscous pitch solution flows readily. The aromatic additive is coal tar oil, wash oil, anthracene, naphthalene, cetane, methyl naphthalene, or reduced oil. The aromatic additive is added to the pitch solution while the pitch solution is being blended; hence, the aromatic additive and the pitch solution mix quickly. The blending process takes 10˜60 minutes, preferably 20˜40 minutes.

Step C entails adding an aliphatic additive to the pitch solution to coalesce solid particles suspended in the pitch solution; hence quinoline insoluble (QI) in the pitch solution coalesce to become heavier and denser, thereby facilitating subsequent steps. The aliphatic additive is kerosene, decane, or ketene. The aliphatic additive is added to the pitch solution while the pitch solution is being blended; hence, the aliphatic additive and the pitch solution mix quickly. The blending process takes 1˜40 minutes, preferably 5˜30 minutes.

Step D entails performing a quiescent sedimentation process to thereby achieve separation of the pitch solution and QI because of a difference in density. It is because the aliphatic additive causes the QI to coalesce and turn into a solid coalesced substance with a higher density. After the quiescent sedimentation process has taken place for a period of time, the denser QI coalesced substance settles gradually to thereby separate the QI from the pitch solution. The quiescent sedimentation process takes 60˜180 minutes, preferably 100˜150 minutes.

The method of manufacturing a refined pitch further comprises step F. Step F entails performing a vacuum distillation process on the liquid part extracted in step E, so as to remove the aromatic and aliphatic additives. As its name suggests, the vacuum distillation process enables distillation to occur at a pressure below the atmospheric pressure. The lower the pressure under which distillation occurs, the easier the aromatic and aliphatic additives can be removed by the distillation. According to the present invention, steps A˜F are repeated to further refine the pitch.

In order to achieve the above and other objectives, the present invention further provides a method of manufacturing a mesophase pitch, comprising the steps of: (1) providing a pitch and performing a heated blending process thereon to produce a pitch solution; (2) adding an aromatic additive to the pitch solution; (3) adding an aliphatic additive to the pitch solution; (4) performing a quiescent sedimentation process on the pitch solution; (5) separating a liquid part from the pitch solution; (6) performing a vacuum distillation process on the liquid part; and (7) performing a heat processing process on the liquid part. Therefore, the present invention enables a concentrated mesophase pitch to be manufactured.

The above overview, the description below, and the accompany drawings together explain the means and measures taken to achieve the predetermined objectives of the present invention and the advantages of the present invention. The other related objectives and advantages of the present invention are explained by the description below and the accompanying drawings.

### BRIEF DESCRIPTION

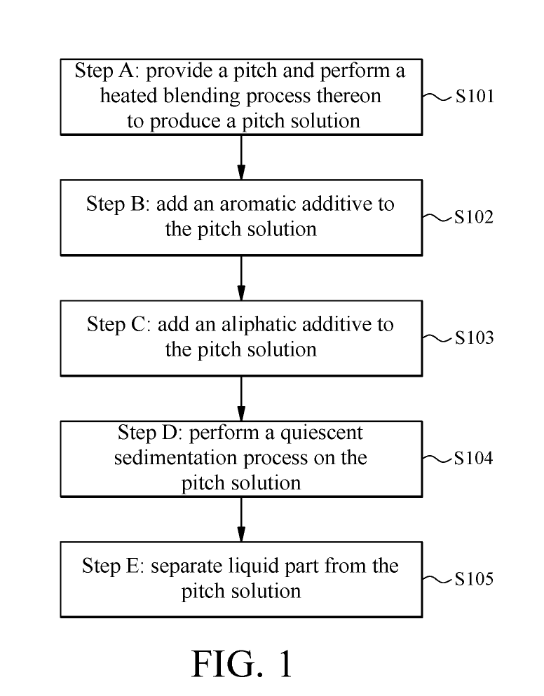

FIG. 1 is a schematic view of the process flow of a method of manufacturing a refined pitch according to the present invention.

### DETAILED DESCRIPTION

The implement of the present invention is illustrated with specific embodiments and described below such that persons skilled in the art can easily understand the other advantages and effects of the present invention by referring to the disclosure presented hereunder.

Referring to FIG. 1, there is shown a schematic view of the process flow of a method of manufacturing a refined pitch according to the present invention. As shown in the diagram, the present invention provides a method of manufacturing a refined pitch, comprising the steps as follows:

Step A: providing a pitch and performing a heated blending process thereon to produce a pitch solution (S101). The heated blending process, which ensures that the pitch is heated beyond the softening point, is performed at a heating temperature of 100˜200° C., preferably 120˜180° C., to melt and turn the solid (at normal temperature) pitch into a liquid (at temperature above the softening point) pitch. Nonetheless, the pitch solution remains viscous even after the solid pitch has been heated beyond the softening point to become a pitch solution.

Step B: adding an aromatic additive to the pitch solution (S102). Step B entails blending the pitch solution to mix the aromatic additive and the pitch (solute) evenly. The blending process takes 10˜60 minutes, preferably 20˜40 minutes. The aromatic additive is introduced to dissolve the pitch, so as to reduce the coefficient of viscosity of the pitch and thus enhance the readiness of the pitch solution to flow. In this embodiment, the aromatic additive is coal tar oil, wash oil, anthracene, naphthalene, cetane, methyl naphthalene, or reduced oil.

Step C: adding an aliphatic additive to the pitch solution (S103). Step C aims to increase the chance that the QI in the pitch solution will coalesce to become heavier and denser. The blending process takes 1˜40 minutes, preferably 5˜30 minutes, such that the QI which is otherwise suspended in the pitch solution coalesce to become heavier and thus different markedly from the pitch solution in density. The aliphatic additive is kerosene, decane, or ketene.

Step D: performing a quiescent sedimentation process on the pitch solution (S104). The quiescent sedimentation process takes place while the pitch solution is idle at a temperature of 60˜140° C., preferably 80˜120° C., for 60˜180 minutes, preferably 100˜150 minutes.

Step E: separating a liquid part from the pitch solution (S105). The separation techniques for use in step E come in various forms. For example, in this embodiment, the supernatant part of the pitch solution is extracted by an extraction technique, but the present invention is not limited thereto. It is because, at this point in time, most of the QI in the pitch solution is overly dense and thus settles. Hence, the uppermost portion of the pitch solution is most thoroughly refined, thereby obtaining the pitch solution with QI content of less than 0.05 wt %. In other words, upon removal of the additives introduced in step B and step C, the pitch solution is cooled down to produce the desired pitch solution with QI content of less than 0.05 wt %. To give considerations to the yield, it is feasible to extract the pitch solution with any other related technique such that, by repeating the pitch refining steps A˜E, a refined pitch solution with QI content of less than 0.05 wt % is obtained.

Table 1 below shows combinations of parameters of the pitch, the aromatic additive, and the aliphatic additive. As shown in Table 1, combination No. 1 has a pitch—aromatic additive—aliphatic additive ratio of 1:1:0 by weight, resulting in a refined pitch with 1.81 wt % QI content and 29.3 wt % TI content. Combination No. 2 has a pitch—aromatic additive—aliphatic additive ratio of 4:3:1 by weight, resulting in a refined pitch with 0.76 wt % QI content and 26.9 wt % TI content. Combination No. 3 has a pitch—aromatic additive—aliphatic additive ratio of 2.6:1.6:1 by weight, resulting in a refined pitch with 0.01 wt % QI content and 27.7 wt % TI content, thereby indicating that the resultant refined pitch (with QI content of less than 0.05 wt %) is of high quality. Combination No. 4 has a pitch—aromatic additive—aliphatic additive ratio of 2:1:1 by weight, resulting in a refined pitch with 0.01 wt % QI content and 13 wt % TI content. Combination No. 5 has a pitch—aromatic additive—aliphatic additive ratio of 4:1:3 by weight, resulting in a refined pitch with 0.01 wt % QI content and 1.3 wt % TI content. Combination No. 6 has a pitch—aromatic additive—aliphatic additive ratio of 1:0:1 by weight, with the solvent being unable to dissolve the pitch, supernatant pitch liquid cannot be extracted from the pitch solution, thereby precluding the estimation of the yield, QI content, and TI content of the refined pitch.

TABLE 1
combinations of parameters of pitch, aromatic additive, and
aliphatic additive

| No. | Pitch:aromatic additive:aliphatic additive | QI (wt %) | TI (wt %) |
|---|---|---|---|
| 1 | 1:1:0 | 1.81 | 29.3 |
| 2 | 4:3:1 | 0.76 | 26.9 |
| 3 | 2.6:1.6:1 | −0.01 | 27.7 |
| 4 | 2:1:1 | −0.01 | 13 |
| 5 | 4:1:3 | −0.01 | 1.3 |
| 6 | 1:0:1 | N.A. | N.A. |

The refined pitch with low QI content undergoes heat processing for a short while to convert quickly into a concentrated mesophase pitch, thereby reducing heat processing time, manpower and costs. According to the present invention, the refined pitch indicated by No. 3 in Table 1 undergoes a heat processing process again. The heat processing process occurs at a temperature of 350˜450° C., preferably 380˜420° C., for 2˜10 hours, preferably 4˜8 hours. Therefore, the present invention enables a concentrated mesophase pitch to be manufactured.

The present invention is disclosed above by preferred embodiments. However, persons skilled in the art should understand that the preferred embodiments are illustrative of the features and advantages of the present invention only, but should not be interpreted as restrictive of the scope of the present invention. Hence, all modifications and changes made to the aforesaid embodiments without departing from the spirit and scope of the present invention should fall within the scope of the present invention. Accordingly, the legal protection for the present invention should be defined by the appended claims.

What is claimed is:

1. A method of manufacturing a refined pitch, comprising the steps of:
A: providing a pitch;
B: providing an aromatic additive and an aliphatic additive, with the aromatic being one of anthracene and naphthalene, and the aliphatic being decane;
wherein a ratio of a sum of weight of the aromatic additive and weight of the aliphatic additive to weight of the pitch is 1:1, wherein a ratio of weight of the aromatic additive to weight of the aliphatic additive is 1:0.625˜3;
C: performing a heated blending process on the pitch to produce a pitch solution, wherein the heated blending process is performed at a control temperature of 100˜200° C.;
D: adding the aromatic additive to the pitch solution;
E: adding the aliphatic additive to the pitch solution;
F: performing a quiescent sedimentation process on the pitch solution; and
G: separating a liquid part from the pitch solution to obtain the pitch with less than 0.05 wt % quinoline insoluble (QI);

2. The method of claim 1, wherein the control temperature is 120˜180° C.

3. The method of claim 1, wherein a ratio of weight of the pitch to weight of the aromatic additive is larger than 1 but not larger than 2.5.

4. The method of claim 1, wherein a ratio of weight of the pitch to weight of the aliphatic additive is larger than 1 but not larger than 2.5.

5. The method of claim 1, wherein step C further comprises a step of blending the pitch solution continuously for a period of time, that is, 10˜60 minutes.

6. The method of claim 1, wherein step C further comprises a step of blending the pitch solution continuously for a period of time, that is, 20˜40 minutes.

7. The method of claim 1, wherein step D further comprises a step of blending the pitch solution continuously for a period of time, that is, 1˜40 minutes.

8. The method of claim 1, wherein step E further comprises a step of blending the pitch solution continuously for a period of time, that is, 5˜30 minutes.

9. The method of claim 1, wherein, in step F, the quiescent sedimentation process takes 60˜180 minutes.

10. The method of claim 1, wherein, in step F, the quiescent sedimentation process takes 100˜150 minutes.

11. The method of claim 1, further comprising step H of performing a vacuum distillation process on the liquid part.

12. The method of claim 13, wherein steps A˜H are repeated to further refine the pitch.

13. A method of manufacturing a mesophase pitch, comprising the steps of:
(1) providing a pitch;
(2) providing an aromatic additive and an aliphatic additive, with the aromatic being one of anthracene and naphthalene, and the aliphatic being decane, wherein a ratio of a sum of weight of the aromatic additive and weight of the aliphatic additive to weight of the pitch is 1:1, wherein a ratio of weight of the aromatic additive to weight of the aliphatic additive is 1:0.625˜3;
(3) performing a heated blending process on the pitch to produce a pitch solution, wherein the heated blending process is performed at a control temperature of 100˜200° C.;
(4) adding the aromatic additive to the pitch solution;
(5) adding the aliphatic additive to the pitch solution;
(6) performing a quiescent sedimentation process on the pitch solution;
(7) separating a liquid part from the pitch solution to obtain the pitch with less than 0.05 wt % quinoline insoluble (QI);
(8) performing a vacuum distillation process on the liquid part; and
(9) performing a heat processing process on the liquid at a temperature of 350˜450° C.

14. The method of claim 13, wherein, in step (3), the heated blending process is performed at the temperature of 120˜180° C.

15. The method of claim 13, wherein a ratio of weight of the pitch to weight of the aromatic additive is larger than 1 but not larger than 2.5.

16. The method of claim 13, wherein a ratio of weight of the pitch to weight of the aliphatic additive is larger than 1 but not larger than 2.5.

17. The method of claim 13, wherein step (4) further comprises a step of blending the pitch solution continuously for a period of time, that is, 20˜40 minutes.

18. The method of claim 13, wherein step (5) further comprises a step of blending the pitch solution continuously for a period of time, that is, 5˜30 minutes.

19. The method of claim 13, wherein, in step (6), the quiescent sedimentation process takes 100-150 minutes.

20. The method of claim 13, wherein, in step (9), the heat processing process is performed at a temperature of 380˜420° C.
